(19) United States
(12) Patent Application Publication
(10) Pub. No.: US 2018/0020696 A1
(43) Pub. Date: Jan. 25, 2018

(54) ANIMAL FEED COMPOSITION AND METHOD OF MAKING SAME

(71) Applicant: Benemilk Oy, Raisio (FI)

(72) Inventors: Feng Wan, Issaquah, WA (US); Timothy Martin Londergan, Seattle, WA (US); Merja Birgitta Holma, Raisio (FI); Ilmo Pellervo Aronen, Hinnerjoki (FI); Risto Juhani Mattila, Turku (FI)

(73) Assignee: Benemilk Oy, Raisio (FI)

(21) Appl. No.: 15/547,790

(22) PCT Filed: Feb. 2, 2016
(86) PCT No.: PCT/US16/16134

§ 371 Date: Jul. 31, 2017

Related U.S. Application Data
(60) Provisional application No. 62/111,006, filed on Feb. 2, 2015.

(51) Int. Cl. A23K 20/158; A23K 50/10; A23K 40/00; A23K 20/105

(52) U.S. Cl. CPC A23K 20/158; A23K 20/105; A23K 50/10; A23K 40/00

(57) ABSTRACT

A dietary composition for a ruminant includes a fatty acid composition comprising a fatty acid component and a surfactant component and a feed material, wherein the fatty acid component comprises a rumen stable fatty acid and a weight/weight ratio of the surfactant component. A method and system of preparing a ruminant feed mixture, wherein the method includes preparing a solid mixture by combining a fatty acid composition with at least one feed material, wherein the fatty acid composition comprises a fatty acid component and a surfactant component and conditioning the solid mixture at a conditioning temperature over a period of a conditioning time to provide the ruminant feed mixture.

### CROSS-REFERENCE TO RELATED APPLICATION

This application claims priority to U.S. Application No. 62/111,006, filed Feb. 2, 2015, which is expressly incorporated herein by reference in its entirety.

### BACKGROUND

Increasing production and fat content of milk obtained from lactating ruminants have been major goals for dairy farmers. Additional milk production per ruminant is beneficial because it results in a higher yield, thereby increasing profits. Increased milk solids including milk fat, milk protein or both is desirable because they have high economic value and can be used in highly desirable food products, such as cheese, yogurt, and the like.

### SUMMARY

In one aspect, the disclosure provides dietary compositions for ruminant. In some embodiments, the dietary composition for ruminant comprises a fatty acid composition, comprising a fatty acid component and a surfactant component; and a feed material. In some embodiments, the fatty acid component comprises at least 70% by weight of a rumen stable fatty acid; and a weight/weight ratio of the surfactant component to the fatty acid component is about 1:100 to about 1:1. In some embodiments, the dietary composition includes about 0.5% to about 40% by weight of the fatty acid composition, wherein the fatty acid composition comprises from about 50% to about 99% by weight of the fatty acid component and from about 0.01% to about 20% by weight of the surfactant component; and about 50% to about 99% by weight of the feed material. In some embodiments, the dietary composition further includes about 1% to about 30% by weight of a high oleic oil. In some embodiments, the dietary composition is in pellet form. In some embodiments, the dietary composition is in mash mixture form.

In some embodiments, the fatty acid composition is in prilled solid bead form or solid flake form.

In some embodiments, the fatty acid composition has a melting point at not less than 45° C., 50° C., 60° C. or 70° C.

In some embodiments, the fatty acid composition has a moisture level of not greater than 2%, 1%, 0.5%, or 0.01% by weight.

In some embodiments, the fatty acid composition has a particle size from about 1 μm to about 10 mm. In some embodiments, the fatty acid composition has an average particle size from about 0.5 mm to about 2 mm. In some embodiments, the fatty acid composition has a mean particle size from about 0.5 mm to about 2 mm.

In some embodiments, a weight/weight ratio of the surfactant component to the fatty acid component is from about 1:100 to about 1:1. In some embodiments, a weight/weight ratio of the surfactant component to the fatty acid component is from about 1:10 to about 1:2, or from about 1:20 to about 1:5, or from about 1:20 to about 1:2.

In some embodiments, the fatty acid composition or the dietary composition may further include a nutritional agent. In some embodiments, the nutritional agent comprises an antioxidant, a bioactive agent, a flavoring agent, a colorant, a glucogenic precursor, a vitamin, a mineral, an amino acid, or derivatives thereof.

In some embodiments, the bioactive agent comprises a prebiotic agent, a probiotic agent, an antimicrobial agent, or a combination thereof.

In some embodiments, the glucogenic precursor is glycerol, propylene glycol, propanediol, polyol, or calcium or sodium propionate.

Vitamins may be any natural or synthetic vitamin, or precursor or derivative thereof. In some embodiments, the vitamin is vitamin A, vitamin C, vitamin D, vitamin E, vitamin H, vitamin K, vitamin B₁, vitamin B₂, vitamin B₃, vitamin B₅, vitamin B₆, vitamin B₇, vitamin B₉, vitamin B₁₂, vitamin Bₚ, or a derivative thereof.

In some embodiments, the mineral is a derivative of calcium, sodium, magnesium, phosphorous, potassium, manganese, zinc, selenium, copper, iodine, iron, cobalt, or molybdenum.

The amino acid may be any natural, synthetic, common, uncommon, essential or non-essential amino acid or its precursor or derivative thereof. In some embodiments, the amino acid is carnitine, histidine, alanine, isoleucine, arginine, leucine, asparagine, lysine, aspartic acid, methionine, cysteine, phenylalanine, glutamic acid, threonine, glutamine, tryptophan, glycine, valine, ornithine, proline, selenocysteine, serine, tyrosine, or derivatives thereof.

The surfactant component may be a non-ionic emulsifier or an ionic emulsifier. In some embodiments, the emulsifier has a hydrophilic-lipophilic balance value of about 10 to about 20. In some embodiments, the emulsifier has a hydrophilic-lipophilic balance value of not greater than about 20, 15, 7, 5, 3, or 1.

In some embodiments, the surfactant component comprises lecithin, soy lecithin, cephalin, castor oil ethoxylate, sorbitan mono-, di- or trioleate, tallow ethoxylate, lauric acid, polyethylene glycol, or derivatives thereof. In some embodiments, the surfactant component comprises calcium stearoyl dilaciate, glycerol ester, polyglycerol ester, sorbitan ester, polysorbitan ester, polyethylene glycol ester, sugar ester, mono-, di- or triglyceride, acetylated monoglyceride, lactylated monoglyceride, or derivatives thereof.

In some embodiments, the surfactant component comprises polyoxyethylene stearate, polysorbate, polyoxyethylene sorbitan monolaurate, polyoxyethylene sorbitan monooleate, polyoxyethylene sorbitan monopalmitate, polyoxyethylene sorbitan monostearate, polyoxyethylene sorbitan tristearate, ammonium phosphatides, sodium or potassium or calcium salts of fatty acids, magnesium salts of fatty acids, mono- and diglycerides of fatty acids, acetic acid esters of mono- and diglycerides of fatty acids, lactic acid esters of mono- and diglycerides of fatty acids, citric acid esters of mono- and diglycerides of fatty acids, mono- and diacetyl tartaric acid esters of mono- and diglycerides of fatty acids, acetic acid esters of mono- and diglycerides of fatty acids, tartaric acid esters of mono- and diglycerides of fatty acids, sucrose esters of fatty acids sucroglycerides, polyglycerol esters of fatty acids polyglycerol polyricinoleate, propane-1,2-diol esters of fatty acids, thermally oxidised soya bean oil interacted with mono- and diglycerides of fatty acids, sodium stearoyl-2-lactylate, calcium stearoyl-2-lactylate, sorbitan monostearate, sorbitan tristearate, sorbitan monolaurate, sorbitan monooleate, sorbitan monopalmitate, polysorbate 20, polysorbate 40, polysorbate 60, polysorbate 80, polysorbitan palmitate, polysorbitan stearate, polysorbitan oleate, or derivatives thereof. In some embodiments, the sodium or potassium or calcium salt of fatty acids comprises sodium or potassium or calcium salts of distilled palm fatty acids.

In some embodiments, the surfactant component comprises a surfactant derived from oleic acid. In some embodiments, the oleic acid derived surfactant may be a non-ionic oleate ester derived surfactant or an ionic oleic acid derived surfactant.

In some embodiments, the surfactant component comprises sodium oleate, potassium oleate, calcium oleate, ammonium oleate, sorbitan oleate, sorbitan mono-, di- or trioleate, polysorbate oleate, glyceryl oleate, methyl oleate, ethyl oleate, PEG oleate, triethanolamine oleate (TEA oleate), polysorbate oleate, or a combination thereof.

In some embodiments, the fatty acid component melts at not less than 55° C., 60° C., 65° C., or 70° C.

In some embodiments, the fatty acid component comprises a rumen stable fatty acid. The rumen stable fatty acid may be free fatty acid or esters of free fatty acid. In some embodiments, the fatty acid component may include rumen stable fatty acid not less than about 70%, 80%, 85%, 90%, 95%, 98%, or 99% by weight. In some embodiments, the fatty acid component may include free fatty acid not less than about 70%, 80%, 85%, 90%, 95%, 98%, or 99% by weight. In some embodiments, the fatty acid component comprises at least about 80% of free fatty acid by weight.

In some embodiments, the fatty acid component comprises at least 70% of a palmitic acid compound by weight. In some embodiments, the fatty acid component comprises at least 95% of a palmitic acid compound by weight.

In some embodiments, the palmitic acid compound comprises free palmitic acid, palmitate triglyceride, one or more salts of palmitic acid. In some embodiments, the salt of palmitic acid comprises sodium palmitate, calcium palmitate, magnesium palmitate, ammonium palmitate, zinc palmitate, aluminum palmitate, copper palmitate, iron palmitate, chromium palmitate, selenium palmitate, or a combination thereof. In some embodiments, the fatty acid component comprises at least 90% of free palmitic acid by weight.

In some embodiments, the fatty acid component comprises a stearic acid compound. In some embodiments, the stearic acid compound is free stearic acid, stearate triglyceride, sodium stearate, calcium stearate, magnesium stearate, ammonium stearate, conjugated stearic acid, unconjugated stearic acid, or a stearic acid derivative.

In some embodiments, the fatty acid component consists essentially of a palmitic acid compound and a stearic acid compound. In some embodiments, the fatty acid component consists essentially of free palmitic acid and free stearic acid having a weight/weight ratio from about 10:1 to about 1:10. In some embodiments, the weight/weight ratio is from about 6:4 to about 4:6.

In some embodiments, the fatty acid component comprises an oleic acid compound. In some embodiments, the oleic acid compound may be free oleic acid, an oleic acid ester, mono-, di- or triglyceride of oleic acid, a high oleic oil, or a combination thereof.

In some embodiments, the high oleic oil has not less than about 35% of oleic content by weight. In some embodiments, the high oleic oil has not less than about 40% by weight of oleic content. In some embodiments, the high oleic oil has not less than about 50%, 60%, or 70% of oleic content by weight. In some embodiments, the high oleic oil comprises rapeseed oil. In some embodiments, the high oleic oil comprises olive oil.

In some embodiments, the fatty acid component comprises from about 1% to about 50% by weight of high oleic oil. In some embodiments, the fatty acid component comprises from about 1% to about 30% by weight of high oleic oil. In some embodiments, the fatty acid component comprises from about 1% to about 50% by weight of the oleic acid compound.

In some embodiments, the fatty acid component may contain an oil. The oil may be plant based or animal fat based. In some embodiments, the fatty acid component comprises olive oil, pecan oil, rapeseed oil, peanut oil, macadamia oil, sunflower oil, corn oil, cottonseed oil, flaxseed oil, algal oil, palm oil, soybean oil, grape seed oil, sea buckthorn oil, chicken fat, turkey fat, lard, or a combination thereof.

In some embodiments, the fatty acid component comprises from about 1% to about 40% of rapeseed oil by weight. In some embodiments, the fatty acid component comprises free palmitic acid and rapeseed oil at a ratio from about 50:1 to about 1:1 by weight.

In some embodiments, the fatty acid component comprises unsaponifiable matter no greater than 45% by weight. In some embodiments, the fatty acid component comprises unsaponifiable matter no greater than 25% by weight. In some embodiments, the fatty acid component comprises unsaponifiable matter no greater than 15% by weight. In some embodiments, the fatty acid component comprises unsaponifiable matter no greater than 30%, 20%, 10%, 5%, or 2% by weight.

In some embodiments, the fatty acid component has an Iodine Value not greater than about 45, 30, 25, 15, 5, or 1. In some embodiments, the fatty acid component has an Iodine Value from about 1 to about 30.

In some embodiments, the feed material comprises a roughage, a forage, a silage, a grain, or an oilseed meal. In some embodiments, the feed material comprises a polysaccharide, an oligosaccharide, a cellulose, a hemicellulose, a lignocellulose, a sugar or a starch. In some embodiments, the feed material is derived from wood.

In some embodiments, the feed material comprises sugar beet pulp, sugar cane, molasses, wheat bran, oat hulls, grain hulls, soybean hulls, peanut hulls, brewery by-product, yeast derivatives, grasses, hay, seeds, fruit peels, fruit pulps, legumes, plant-based feedstuffs, wheat, corn, oats, sorghum, millet, algae, or barley.

In some embodiments, the feed material comprises soy meals, bean meals, rapeseed meals, sunflower meals, coconut meals, palm kernel meal, olive meals, linseed meals, grapeseed meals, cottonseed meals, or mixtures thereof.

In some embodiments, the feed material comprises a glucogenic precursor, a vitamin, a mineral, an amino acid, or an amino acid derivative.

In some embodiments, a dietary composition comprises a fatty acid component, a surfactant component, and a feed material. In some embodiments, the fatty acid component melts at not less than 50° C. In some embodiments, the fatty acid component has an Iodine Value not greater than 30. In some embodiments, the surfactant component comprises a surfactant derived from oleic acid. In some embodiments, the surfactant component comprises polysorbate or sorbate. In some embodiments, the surfactant component comprises polysorbitan oleate not less than 30%, 45%, or 50% by weight.

In some embodiments, a dietary composition consists of a fatty acid component; a surfactant component; a high oleic oil; and a feed material, wherein the fatty acid composition melts at not less than 50° C.; wherein the fatty acid component has an Iodine Value not greater than 30; and wherein the high oleic oil has an oleic content not less than 35% by weight. In some embodiments, the dietary composition comprises about 3% to about 40% by weight of the fatty acid component; about 0.01% to about 10% by weight of a surfactant component; and about 1% to about 30% by weight of the high oleic oil.

In another aspect, the disclosure provides methods for preparing a ruminant feed mixture. In some embodiments, the method comprises preparing a solid mixture by combining a fatty acid composition with at least one feed material, wherein the fatty acid composition comprises a fatty acid component and a surfactant component and conditioning the solid mixture at a conditioning temperature over a period of a conditioning time to provide the ruminant feed mixture.

In some embodiments, the fatty acid composition is in prilled solid bead form or solid flake form.

In some embodiments, the method furthering comprises the step of adding a high oleic oil into the solid mixture before conditioning the solid mixture. In some embodiments, the method further comprises the step of adding a high oleic oil into the ruminant feed material.

In some embodiments, the feed material has an average particle size not greater than 10 mm. In some embodiments, the feed material has an average particle size from about 10 μm to about 10 mm.

In some embodiments, the solid mixture has a moisture level of not greater than 12% by weight. In some embodiments, the solid mixture has a moisture level of not greater than 10% by weight. In some embodiments, the solid mixture has a moisture level of from about 0.1% by weight to about 10% by weight.

In some embodiments, the solid mixture has a particle size not greater than 20 mm. In some embodiments, the solid mixture has a particle size from about 10 μm to about 10 mm. In some embodiments, the solid mixture has a particle size from about 10 μm to about 20 mm.

In some embodiments, before conditioning, a liquid component may be mixed with the solid mixture. In some embodiments, the mixing is carried out by spraying the liquid component into the solid mixture. In some embodiments, the liquid component is sprayed into the solid mixture in a mist having a particle size not greater than 1500 μm. In some embodiments, the liquid component is sprayed into the solid mixture in a mist having a particle size from about 1 μm to about 1500 μm. In some embodiments, the liquid component is sprayed into the solid mixture over a period of time not less than 20 seconds. In some embodiments, the liquid component is sprayed into the solid mixture over a period of time from about 20 seconds to about 60 seconds. In some embodiments, the liquid component is sprayed into the solid mixture over a period of time from about 30 seconds to about 40 seconds.

In some embodiments, mixing the liquid component is carried out at ambient temperature. In some embodiments, mixing the liquid component is carried out at a temperature sufficient to melt the fatty acid component. In some embodiments, mixing is carried out at room temperature.

In some embodiments, the liquid component comprises water. In some embodiments, the liquid component comprises a glucogenic precursor. In some embodiments, the liquid component comprises glycerol, propylene glycol, glycerin, propanediol, vinasse or molasses.

In some embodiments, the ruminant feed mixture comprises the surfactant component from about 0.001% to about 10% by weight. In some embodiments, the ruminant feed mixture comprises the surfactant component from about 0.01% to about 5% by weight.

In some embodiments, the ruminant feed mixture comprises the fatty acid component from about 2% to about 50% by weight. In some embodiments, the ruminant feed mixture comprises the fatty acid component from about 3% to about 15% by weight. In some embodiments, the ruminant feed mixture comprises the fatty acid component from about 10% to about 20% by weight. In some embodiments, the ruminant feed mixture comprises about 10% of the fatty acid component by weight.

In some embodiments, the solid mixture comprises the fatty acid composition from about 3% to about 40% by weight.

In some embodiments, the method further comprises adding a glucogenic precursor into the ruminant feed mixture.

In some embodiments, before preparing the solid mixture, the feed material is ground to an average particle size of about 1 mm to about 10 mm.

In some embodiments, the conditioning time is from about 5 seconds to about 10 minutes. In some embodiments, the conditioning time is from about 5 seconds to about 30 minutes. In some embodiments, the conditioning time is from about 15 seconds to about 3 minutes. In some embodiments, the conditioning time is from about 3 minutes to about 30 minutes. In some embodiments, the conditioning time is from about 5 minutes to about 30 minutes. In some embodiments, the conditioning temperature is not less than a temperature at which the fatty acid component melts.

In some embodiments, the conditioning temperature is about 45° C. to about 65° C. In some embodiments, the conditioning temperature is about 55° C. to about 75° C. In some embodiments, the conditioning temperature is about 55° C. to about 70° C. In some embodiments, the conditioning temperature is about 73° C. to about 80° C. In some embodiments, the conditioning temperature is about 55° C. to about 80° C.

In some embodiments, the method further comprises pressing the ruminant feed mixture into pellets. In some embodiments, the pellets reach not less than about 70° C. after the pressing. In some embodiments, the pellets reach not less than about 81° C. after the pressing.

In some embodiments, the method further comprises cooling the pellets to ambient temperature.

In a further aspect, the disclosure provides systems for making a ruminant feed. In some embodiments, the system comprises a mixer, wherein the mixer contains a solid mixture comprising a fatty acid composition and at least one feed material, wherein the fatty acid composition comprises a fatty acid component and a surfactant component; a steam conditioning vessel, wherein the steam conditioning vessel contains a ruminant feed mixture comprising the solid mixture; and a pellet presser, expander, or extruder.

In some embodiments, the mixer comprises a paddle mixer or a ribbon mixer.

In some embodiments, the pellet presser has a ring die presser, a flat die presser, or a horizontal ring die presser. In some embodiments, the presser has a die diameter from about 4 mm to about 6 mm. In some embodiments, the presser has a die channel from about 40 mm to about 120 mm.

In some embodiments, the system further comprises an oil addition outlet exiting inside the mixer, wherein the oil addition outlet is configured to add an oil into the solid mixture.

In some embodiments, the system further comprises a liquid injecting outlet exiting inside the mixer, wherein the liquid injecting outlet is configured to spray a liquid component into the solid mixture.

In a further aspect, the disclosure provides methods for increasing milk yield, milk fat content, milk protein content, or all three by a ruminant. In some embodiments, the method comprises providing a ruminant feed mixture to the ruminant for ingestion, wherein the ruminant feed mixture is made by the method described therein; and collecting milk from the ruminant after the ruminant has ingested the ruminant feed mixture, wherein milk collected from the ruminant has a milk yield, a higher milk fat content, or a higher milk protein content or all three compared to milk before the ruminant ingested the ruminant feed mixture. In some embodiments the ruminant is a cow, goat, or sheep.

In a further aspect, the disclosure provides dietary compositions. In some embodiments, a dietary composition is made by the method including any one of the embodiments for making a ruminant feed mixture. In some embodiments, the dietary composition is a dry particle, a pellet, a liquid suspension, a paste, or an emulsion.

### BRIEF DESCRIPTION OF THE DRAWINGS

FIG. 1 is a flow diagram of an illustrative method of preparing a ruminant feed mixture and pellets of the fatty acid composition;

FIGS. 2A, 2B, 2C, and 2D are flow diagrams of alternative methods of preparing the ruminant feed mixture;

FIG. 3 is a schematic illustration of a system for preparing the ruminant feed mixture and pellets; and

FIG. 4 is a diagrammatical illustration of a ring die for a ring die presser.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art.

Unless indicated otherwise, percents are weight percents, and ratios are weight/weight ratios.

The following terms shall have, for the purposes of this application, the respective meanings set forth below.

A “ruminant” is generally a suborder of mammal with a multiple chamber stomach that gives the animal the ability to digest cellulose-based food by softening it within a first chamber (rumen) of the stomach and to regurgitate the semi-digested mass to be chewed again by the ruminant for digestion in one or more other chambers of the stomach. Examples of ruminants include, but are not limited to, lactating animals such as cattle, goats and sheep. Cattle may include dairy cows, which are generally animals of the species Bos taurus. The milk produced by ruminants is widely used in a variety of dairy-based products.

The present disclosure generally relates to fatty acid compositions, ruminant feed mixtures, the dietary compositions made therefrom, and to the methods for making the dietary compositions for ruminants. The dietary compositions may be configured to improve various aspects of the ruminants such as milk production or growth. For instance, some embodiments provide that the dietary compositions may increase the amount of milk production (yield) by the ruminant, increase the milk fat, increase the milk protein, or all three. Specific compositions described herein may include ruminant feed mixtures, supplements, or the like. According to some embodiments, the dietary compositions may include liquids, solids or combinations thereof, such as dry particles, pellets, liquid suspensions, emulsions, slurries, pastes, gels, or the like.

When a ruminant consumes feed, the fat in the feed is modified by the rumen to provide a milk fat profile that is different from the profile of fat in the feed. Fats that are not inert in the rumen may decrease feed intake and rumen digestibility of the feed material. Milk composition and fat quality may be influenced by the ruminant's diet. For example, oil feeding (the feeding of vegetable oils, for example) can have negative effects on both rumen function and milk formation. As a result of oil feeding, the milk protein may decrease, the milk fat may decrease, and the proportion of trans fatty acids may increase. These results have been connected with various negative milk characteristics, such as an increase in the harmful low-density lipoprotein (LDL) cholesterol and a decrease in the beneficial high-density lipoprotein (HDL) cholesterol in human blood when the milk is consumed. In addition, the properties of the milk fat during industrial milk processing may be weakened. A high level of polyunsaturated fatty acids in milk can also cause taste defects and preservation problems. A typical fatty acid composition of milk fat may contain more than about 70% by weight saturated fatty acids and a total amount of trans fatty acids may be from about 3% to about 10% by weight. When vegetable oil is added into the feed, the proportion of trans fatty acids may rise to more than about 10% by weight.

One solution to diminishing the detrimental effect of oil and fat is to reduce fat bio-hydrogenation in rumen. One example is to feed the ruminant insoluble fatty acid calcium salts whereby hydrogenation in the rumen can be reduced. However, fatty acid salts typically have a pungent taste that may result in decreased feed intake by the ruminant. In addition, the salts may also disturb certain processes for forming the feed into pellets.

Fat bio-hydrogenation can be decreased using rumen inert fat or fatty acid. Rumen inert fat refers to the fat or fatty acid with reduced rumen bio-hydrogenation. In some examples, when passing through the rumen, rumen inert fat or fatty acid experiences less than about 50%, about 40%, 40%, 20%, 10%, 5%, 2%, or 1% bio-hydrogenation. In some examples, rumen inert fat or fatty acid may pass through the rumen substantially unchanged.

A fatty acid component, described herein, may allow for the transfer of a fatty acid from the feed via the digestive tract into the blood circulation of a ruminant. This may improve the energy efficiency of milk production and the utilization of energy by the ruminant. When the utilization of energy becomes more effective, milk production may increase and milk protein and fat may rise. According to some embodiments, the dietary composition may be configured to enhance fat synthesis in the mammary gland by bringing milk fat components to the cell such that energy consumed in the milk fat synthesis in the mammary gland is reduced. As a result, glucose may be used more efficiently for lactose production causing increased milk production. In addition, the milk protein may increase because there is less need to produce glucose from amino acids. Accordingly, the weight loss at the beginning of the lactation period may reduce, thereby improving the fertility of the ruminant.

A surfactant component, described herein, may enhance rumen function when digested by a ruminant. For example, the surfactant component may increase the emulsification of ruminal liquid, the growth rate of rumen microbes, the number of ruminal microorganisms, the activity of enzymes secreted by ruminal microbes, or fermentation of cellulosic materials, which may lead to increased digestibility of roughages or crude fibers in rumen and increases feed efficiency. In some embodiments, the ruminal microbes may include without limitation microbial protease and cellulase. In some embodiments, the cellulosic materials may include without limitation fibers, silage, and roughages. The surfactant component may also change the contents and proportion of volatile fatty acids and enhance the feed efficiency and performance by improving the rumen fermentation characteristics.

Additionally or alternatively, the surfactant component, described herein, may improve the digestibility of the fatty acid component, the feed materials or any part thereof when an animal consumes the dietary composition. For example, the surfactant component or any part thereof may aid in the micelle formation of the fatty acid component or the feed material in the animal's digestive tract, enhance the emulsification process, and/or facilitate the digestion and/or absorption of the fatty acid component or feed material.

Additionally or alternatively, the surfactant component, described herein, may facilitate the feed composition making process. For example, the surfactant component may help the spreading, coating, mixing, or incorporation of the fatty acid component into the feed material. In some embodiments, the surfactant component may facilitate the feed pellet or particle formation, improve the pellet quality, or both.

In one aspect, the disclosure provides dietary compositions for ruminant. In some embodiments, the dietary composition for a ruminant comprises a fatty acid composition, comprising a fatty acid component and a surfactant component and a feed material. In some embodiments, the fatty acid component comprises at least 70% by weight of a rumen stable fatty acid; and a weight/weight ratio of the surfactant component to the fatty acid component is about 1:100 to about 1:1. In some embodiments, the dietary composition includes about 0.5% to about 40% by weight of the fatty acid composition, wherein the fatty acid composition comprises from about 50% to about 99% by weight of the fatty acid component and from about 0.01% to about 20% by weight of the surfactant component; and about 50% to about 99% by weight of the feed material. In some embodiments, the dietary composition further includes about 1% to about 30% by weight of a high oleic oil. In some embodiments, the dietary composition is in pellet form. In some embodiments, the dietary composition is in mash mixture form.

In some embodiments, the fatty acid composition melts at not less than 40° C., and the fatty acid component has an Iodine Value not greater than 45. In some embodiments, the fatty acid composition can consist essentially of a fatty acid component and a surfactant component. In some embodiments, the fatty acid composition can consist of a fatty acid component and a surfactant component. In some embodiments, the fatty acid composition can comprise about 75% to about 99.99% by weight of a fatty acid component; and about 0.01% to about 30% by weight of a surfactant component.

In some embodiments, the fatty acid composition is in a free flowing solid form. In some embodiments, the fatty acid composition is formed as prilled solid beads. In some embodiments, the fatty acid composition is formed as solid flakes. In some embodiments, the fatty acid composition melts at not less than about 45° C., about 50° C., about 60° C., or about 70° C. In some embodiments, the fatty acid composition has a moisture level of not greater than 2%, 1%, 0.5%, or 0.01% by weight.

In some embodiments, the fatty acid composition includes particles having a particle size from about 1 μm to about 10 mm. In some embodiments, the fatty acid composition has an average particle size from about 0.5 mm to about 2 mm. In some embodiments, the fatty acid composition includes particles having a particle size not greater than 10 mm. In some embodiments, the fatty acid composition includes particles having a particle size from about 10 μm to about 2 mm. In some embodiments, the fatty acid composition includes particles having an average particle size of about 0.5 mm, 1 mm or 2 mm. In some embodiments, the fatty acid composition includes particles having a mean particle size of about 0.5 mm, 1 mm, or 2 mm. In some embodiments, the fatty acid composition has a mean particle size from about 0.5 mm to about 2 mm.

In some embodiments, the fatty acid composition can have a weight/weight ratio of the surfactant component to the fatty acid component of about 1:100 to about 1:1, or about 1:20 to about 1:1, or about 1:10 to about 1:2, or about 1:10 to about 1:3, or about 1:20 to about 1:5, or about 1:20 to about 1:2.

In some embodiments, the fatty acid composition can comprise no more than 20% by weight of the surfactant component. In some embodiments, the fatty acid composition can comprise no more than 10% by weight of the surfactant component, or no more than 15% by weight of the surfactant component, or no more than 25% by weight of the surfactant component, or from about 0.01% to about 30% by weight of the surfactant component.

In some embodiments, the fatty acid composition can further comprise a nutritional agent or a carrier, such as a porous carrier material.

In some embodiments, the porous carrier material can include protein, grain, roughage, or a metal-organic framework.

In some embodiments, the nutritional agent can comprise an antioxidant, a bioactive agent, a flavoring agent, a colorant, a glucogenic precursor, a vitamin, a mineral, an amino acid, a trace element, or derivatives thereof.

In some embodiments, the antioxidant to be added to the fatty acid composition can include ethoxyquin (1,2-dihydro-6-ethoxy-2,2,4-trimethylquinoline), BHA (butylated hydroxyanisole), BHT (butylated hydroxytoluene), ascorbic acid, ascorbyl palmitate, benzoic acid, calcium ascorbate, calcium propionate, calcium sorbate, citrate acid, dilauryl thiodipropionate, distearyl thiodipropionate, erythorbic acid, formic acid, methylparaben, potassium bisulphite, potassium metabisulphite, potassium sorbate, propionic acid, propyl gallate, propyl paraben, resin guaiae, sodium ascorbate, sodium benzoate, sodium bisulphite, sodium metabisulphite, sodium nitrite, sodium propionate, sodium sorbate, sodium sulphite, sorbic acid, stannous chloride, sulphur dioxide, THBP (trihydroxy-butyrophenone), TBHQ (tertiary-butylhydroquinone), thiodipinic acid, tocopherols, polyphenol, carotenoid, flavonoids, flavones, quinones, or derivatives thereof.

In some embodiments, the bioactive agent can include a prebiotic agent, a probiotic agent, an antimicrobial agent or combinations thereof. Prebiotic agents include fructo-oligosaccahrides, inulin, galacto-oligosaccahride, mannan-oligosaccahride, a yeast, a component of a yeast, a yeast extract, or a combination thereof. Probiotic agents include, without limitation, lactic acid-producing bacteria, live yeast cells, yeast culture, enzymes such as protease and amylase. Antimicrobial agents include, without limitation, monensin, bambermycin, lasalocid, salinomycin, a sesquiterpene, a terpene, an alkaloid, an essential oil, or their derivatives.

In some embodiments, the glucogenic precursor can include glycerol, propylene glycol, propanediol, polyol, or calcium or sodium propionate.

In some embodiments, vitamins can include biotin, vitamin A, vitamin C, vitamin D, vitamin E, vitamin H, vitamin K, vitamin B₁, vitamin B₂, vitamin B₃, vitamin B₅, vitamin B₆, vitamin B₇, vitamin B₉, vitamin B₁₂, vitamin Bₚ, or a derivative thereof.

In some embodiments, minerals can include derivatives of calcium, sodium, magnesium, phosphorous, potassium, manganese, zinc, selenium, copper, iodine, iron, cobalt, or molybdenum. In some embodiments of the fatty acid composition, the mineral is an amino acid chelated or glycinated mineral or selenium yeast. In some embodiments of the fatty acid composition, the mineral is an organic mineral derivative.

The amino acid may be any natural, synthetic, common, uncommon, essential or non-essential amino acid or its precursor or derivative thereof. In some embodiments, amino acids can include carnitine, histidine, alanine, isoleucine, arginine, leucine, asparagine, lysine, aspartic acid, methionine, cysteine, phenylalanine, glutamic acid, threonine, glutamine, tryptophan, glycine, valine, ornithine, proline, selenocysteine, selenomethionine, serine, tyrosine, or derivatives thereof.

In some embodiments, the surfactant component can include a non-ionic emulsifier or an ionic emulsifier. In some embodiments, the emulsifier can have a hydrophilic-lipophilic balance (HLB) value of about 5 to about 25. In some embodiments, the emulsifier can have a hydrophilic-lipophilic balance (HLB) value of about 10 to about 20. In some embodiments, the emulsifier can have a hydrophilic-lipophilic balance (HLB) value of about 15. In some embodiments, the emulsifier can have a hydrophilic-lipophilic balance (HLB) value of not greater than about 20, 15, 8, 7, 4, or 1. In some embodiments, the HLB value provides an indication of the degree to which a surfactant component is hydrophilic or lipophilic. HLB values can be determined formulaically by assigning values to certain regions of the surfactant molecule. The HLB value can be determined by one of several well-known methods, including, for example, Griffin's method.

In some embodiments, the surfactant component can include lecithin, soy lecithin, cephalin, castor oil ethoxylate, sorbitan monooleate, tallow ethoxylate, lauric acid, polyethylene glycol, or derivatives thereof.

In some embodiments, the surfactant component can include calcium stearoyl dilaciate, glycerol ester, polyglycerol ester, sorbitan ester, polysorbitan ester, polyethylene glycol ester, sugar ester, mono-, di- or triglyceride, acetylated monoglyceride, lactylated monoglyceride, or derivatives thereof.

In some embodiments, the surfactant component can include polyoxyethylene stearate, polysorbate, polyoxyethylene sorbitan monolaurate, polyoxyethylene sorbitan monooleate, polyoxyethylene sorbitan monopalmitate, polyoxyethylene sorbitan monostearate, polyoxyethylene sorbitan tristearate, ammonium phosphatides, sodium or potassium or calcium salts of fatty acids, magnesium salts of fatty acids, mono- and diglycerides of fatty acids, acetic acid esters of mono- and diglycerides of fatty acids, lactic acid esters of mono- and diglycerides of fatty acids, citric acid esters of mono- and diglycerides of fatty acids, mono- and diacetyl tartaric acid esters of mono- and diglycerides of fatty acids, acetic acid esters of mono- and diglycerides of fatty acids, tartaric acid esters of mono- and diglycerides of fatty acids, sucrose esters of fatty acids sucroglycerides, polyglycerol esters of fatty acids, polyglycerol polyricinoleate, propane-1,2-diol esters of fatty acids, thermally oxidised soya bean oil interacted with mono- and diglycerides of fatty acids, sodium stearoyl-2-lactylate, calcium stearoyl-2-lactylate, sorbitan monostearate, sorbitan tristearate, sorbitan monolaurate, sorbitan monooleate, sorbitan monopalmitate, polysorbate 20, polysorbate 40, polysorbate 60, polysorbate 80, polysorbitan palmitate, polysorbitan stearate, polysorbitan oleate, or derivatives thereof. In some embodiments, the sodium or potassium or calcium salts of fatty acids comprises sodium or potassium or calcium salts of distilled palm fatty acids.

In some embodiments, the surfactant component comprises a surfactant derived from oleic acid. The surfactant derived from oleic acid may be a non-ionic oleate ester derived surfactant or an ionic oleic acid derived surfactant. In some embodiments, the surfactant component comprises sodium oleate, potassium oleate, calcium oleate, ammonium oleate, sorbitan oleate, sorbitan mono-, di-, or trioleate, polysorbate oleate, glyceryl oleate, methyl oleate, ethyl oleate, PEG oleate, triethanolamine oleate (TEA oleate), or a combination thereof.

In some embodiments, the fatty acid component melts at not less than 55° C., 60° C., 65° C., or 70° C.

In some embodiments, the fatty acid component comprises a rumen stable fatty acid. The rumen stable fatty acid may be free fatty acid or esters of free fatty acid. In some embodiments, the fatty acid component may include rumen stable fatty acid not less than about 70%, 80%, 85%, 90%, 95%, 98%, or 99% by weight. In some embodiments, the fatty acid component may include free fatty acid not less than about 70%, 80%, 85%, 90%, 95%, 98%, or 99% by weight. In some embodiments, the fatty acid component may include free fatty acid, fatty acid ester, fatty acid salt, or a combination thereof. In some embodiments, the fatty acid component may include about 70%, 80%, 85%, 90%, 95%, 98%, or 99% by weight of free fatty acid. In some embodiments, the fatty acid component comprises at least about 80% of free fatty acid by weight.

In some embodiments, the fatty acid component includes a palmitic acid compound. The palmitic acid compound is not limited by this disclosure, and may include one or more of a conjugated palmitic acid, unconjugated palmitic acid, free palmitic acid, palmitate triglyceride, sodium palmitate, calcium palmitate, magnesium palmitate, ammonium palmitate, and palmitic acid derivatives. Palmitic acid, also known as hexadecanoic acid, has a molecular formula of CH₃(CH₂)₁₄CO₂H. Non-limiting examples of palmitic acid derivatives include palmitic acid esters, palmitic acid amides, palmitic acid salts, palmitic acid carbonates, palmitic acid carbamates, palmitic acid imides, and palmitic acid anhydrides.

In some embodiments, the fatty acid component can include at least 70% of a palmitic acid compound by weight. In some embodiments, the fatty acid component can include at least 95% of a palmitic acid compound by weight.

In some embodiments, the palmitic acid compound can include free palmitic acid, palmitate triglyceride, or one or more salts of palmitic acid. In some embodiments, the salt of palmitic acid can include sodium palmitate, calcium palmitate, magnesium palmitate, ammonium palmitate, zinc palmitate, aluminum palmitate, copper palmitate, iron palmitate, chromium palmitate, selenium palmitate, or a combination thereof. In some embodiments, the fatty acid component includes at least 90% of free palmitic acid by weight. In some embodiments of the fatty acid composition, the fatty acid component can include at least 95%, 98% or 99% of free palmitic acid by weight.

In some embodiments, the fatty acid component includes a stearic acid compound. In some embodiments, the stearic acid compound can include free stearic acid, stearate triglyceride, sodium stearate, calcium stearate, magnesium stearate, ammonium stearate, conjugated stearic acid, unconjugated stearic acid, and stearic acid derivatives. Stearic acid, also known as octadecanoic acid, has a molecular formula of CH₃(CH₂)₁₆CO₂H. Specific examples of stearic acid derivatives may include stearic acid esters, stearic acid amides, stearic acid salts, stearic acid carbonates, stearic acid carbamates, stearic acid imides, and stearic acid anhydrides.

In some embodiments, the fatty acid component can consist essentially of a palmitic acid compound and a stearic acid compound. In some embodiments, the fatty acid component can include a palmitic acid compound and a stearic acid compound. In some embodiments, the fatty acid component can consist essentially of free palmitic acid and free stearic acid having a weight/weight ratio from about 10:1 to about 1:10, a ratio from about 6:4 to about 4:6, or a ratio from about 8:2 to about 2:8.

In some embodiments, the fatty acid component comprises an oleic acid compound. In some embodiments, the oleic acid compound comprises free oleic acid, an oleic acid ester, mono-, di- or triglyceride of oleic acid, a high oleic oil, or a combination thereof. In some embodiments, the fatty acid component comprises from about 1% to about 50% by weight of the oleic acid compound. In some embodiments, the high oleic oil comprises rapeseed oil. In some embodiments, the high oleic oil comprises olive oil.

In some embodiments, the high oleic oil comprises not less than 35% by weight of oleic content. In some embodiments, the high oleic oil comprises not less than 40% by weight of oleic content. In some embodiments, the high oleic oil comprises not less than 50% or 60%, or 70% by weight of oleic content. In some embodiment, the fatty acid component comprises from about 1% to about 50% by weight of high oleic oil. In some embodiment, the fatty acid component comprises from about 1% to about 30% by weight of high oleic oil. In some embodiments, the fatty acid component comprises from about 1% to about 50% by weight of the oleic acid compound.

In some embodiments, the fatty acid component comprises an oil. The oil may be plant based or animal fat based. In some embodiments, the fatty acid component comprises from about 1% to about 50% by weight of the oil.

In some embodiments, the fatty acid component comprises olive oil, pecan oil, rapeseed oil, peanut oil, macadamia oil, sunflower oil, corn oil, cottonseed oil, flaxseed oil, palm oil, soybean oil, grape seed oil, sea buckthorn oil, chicken fat, turkey fat, lard, or a combination thereof. In some embodiments, the fatty acid component comprises from about 1% to about 40% by weight of rapeseed oil. In some embodiments, the fatty acid component comprises free palmitic acid and rapeseed oil at a weight/weight ratio from about 50:1 to about 1:1 by weight.

In some embodiments, the fatty acid component may include a fatty acid salt, a fatty acid ester, a fatty acid amide, a fatty acid anhydride, or a fatty acid alcohol. In some embodiments, the fatty acid component may include one or more free fatty acids and/or glycolipids.

In some embodiments, a fatty acid salt may be any acid addition salt, including, but not limited to, halogenic acid salts such as, for example, hydrobromic, hydrochloric, hydrofluoric, and hydroiodic acid salt; an inorganic acid salt such as, for example, nitric, perchloric, sulfuric, and phosphoric acid salt; an organic acid salt such as, for example, sulfonic acid salts (methanesulfonic, trifluoromethane sulfonic, ethanesulfonic, benzenesulfonic, or p-toluenesulfonic), acetic, malic, fumaric, succinic, citric, benzoic, gluconic, lactic, mandelic, mucic, pamoic, pantothenic, oxalic, and maleic acid salts; and an amino acid salt such as aspartic or glutamic acid salt. The acid addition salt may be a mono- or di-acid addition salt, such as a di-hydrohalogenic, di-sulfuric, di-phosphoric, or di-organic acid salt. In all cases, the acid addition salt is used as an achiral reagent which is not selected on the basis of any expected or known preference for interaction with or precipitation of a specific optical isomer of the products of this disclosure.

In some embodiments, a fatty acid ester includes, for example, a fatty acid ester in a form of RCOOR′. R may be any saturated or unsaturated alkyl group including, without limitation, C10, C12, C14, C16, C18, C20, and C24. R′ may be any group having from about 1 to about 1000 carbon atoms and with or without hetero atoms. In some embodiments, R′ may have from about 1 to about 20, from about 3 to about 10, and from about 5 to about 15 carbon atoms. The hetero atoms may include, without limitation, N, O, S, P, Se, halogen, Si, and B. For example, R′ may be a C₁₋₆alkyl, such as methyl, ethyl or t-butyl; a C₁₋₆alkoxy C₁₋₆alkyl; a heterocyclyl, such as tetrahydrofuranyl; a C₆₋₁₀aryloxyC₁₋₆alkyl, such as benzyloxymethyl (BOM); a silyl, such as trimethylsilyl, t-butyldimethylsilyl and t-butyldiphenylsilyl; a cinnamyl; an allyl; a C₁₋₆alkyl which is mono-, di- or trisubstituted by halogen, silyl, cyano or C₁₋₆aryl, wherein the aryl ring is unsubstituted or substituted by one, two or three, residues selected from the group consisting of C₁₋₇alkyl, C₁₋₇alkoxy, halogen, nitro, cyano and CF₃; or a C₁₋₂alkyl substituted by 9-fluorenyl.

In some embodiments, a fatty acid amide may generally include amides of fatty acids where the fatty acid is bonded to an amide group. For example, the fatty acid amide may have a formula of RCONR′R″. R may be any saturated or unsaturated alkyl group including, without limitation, C10, C12, C14, C16, C18, C20, and C24. R′ and R″ may be any group having from about 1 to about 1000 carbon atoms and with or without hetero atoms. In some embodiments, R′ may have from about 1 to about 20, from about 3 to about 10, and from about 5 to about 15 carbon atoms. The hetero atoms may include, without limitation, N, O, S, P, Se, halogen, Si, and B. For example, R′ and R″ each may be an alkyl, an alkenyl, an alkynyl, an aryl, an aralkyl, a cycloalkyl, a halogenated alkyl, or a heterocycloalkyl group.

In some embodiments, a fatty acid anhydride may generally refer to a compound which results from the condensation of a fatty acid with a carboxylic acid. Illustrative examples of carboxylic acids that may be used to form a fatty acid anhydride include acetic acid, propionic acid, benzoic acid, and the like.

In some embodiments, a fatty acid alcohol refers to a fatty acid having straight or branched, saturated, radical groups with 3-30 carbon atoms, and one or more hydroxy groups. The alkyl portion of the alcohol component can be propyl, butyl, pentyl, hexyl, iso-propyl, iso-butyl, sec-butyl, tert-butyl, or the like. One of skill in the art may appreciate that other alcohol groups may also useful in the present disclosure.

In some embodiments, the fatty acid component can have a moisture level of not greater than about 1%, 0.5%, 0.01% by weight.

In some embodiments, the fatty acid component can include unsaponifiable matter no greater than 45%, or no greater 25% by weight, or no greater than 15% by weight, or no greater than 2% by weight. In some embodiments, the fatty acid component comprises unsaponifiable matter no greater than 30%, 20%, 10%, 5%, or 2% by weight.

In some embodiments, the fatty acid component can have an Iodine Value not greater than 45, 30, 25, 15, 5, or 1. In some embodiments, the fatty acid component can have an Iodine Value from about 1 to about 30. The Iodine Value is also sometimes referred to in the literature as the Iodine Number. The Iodine Value provides a measure of the unsaturation of a chemical material. Accordingly, the fatty acid component may include some unsaturated fatty acid compounds. The Iodine Value is a measure of iodine absorbed in a given amount of time by the fatty acid component. For example, the Iodine Value can represent the number of grams of iodine consumed by 100 grams of the fatty acid component. The lower the Iodine Value is, the lower the degree of unsaturation. A well-known method of determining the Iodine Value is the Wijs Method. However, the disclosure is not limited to using any one specific method of determining the Iodine Value. It is also possible that other methods of determining the degree of unsaturation may not involve the use of iodine or another halogen. It is therefore intended herein that the “Iodine Value” gives a representation of the degree of unsaturation by whatever method, and is not to be construed as limited solely to the iodine method.

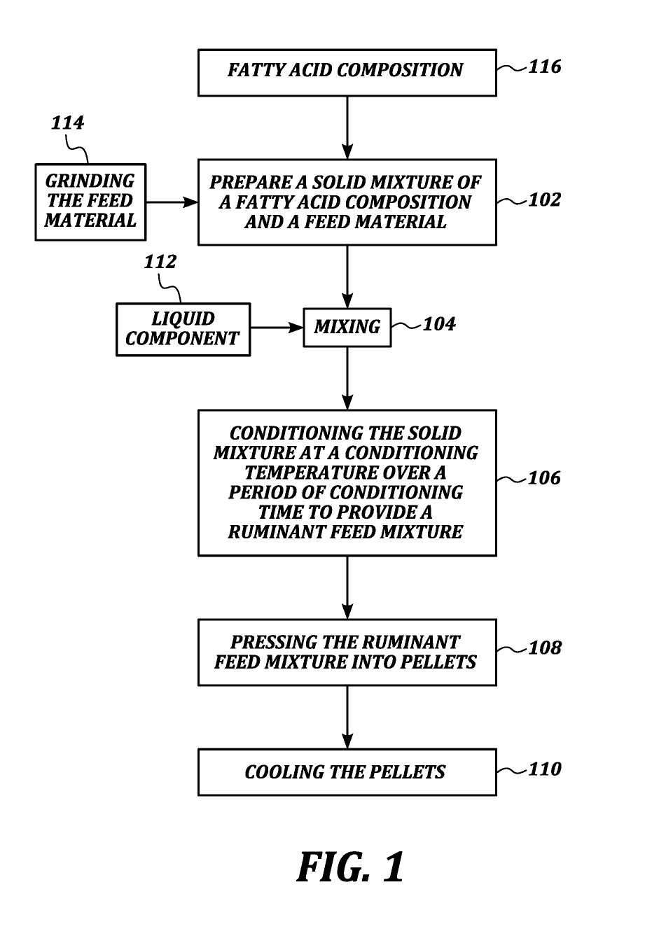

FIG. 1 depicts a flow diagram of one embodiment of a method of preparing a ruminant feed mixture with the fatty acid compositions described herein. Ruminant feed mixtures prepared according to embodiments described herein may be more stable and more digestible by ruminants in a manner that leads to improved milk production, milk fat, milk protein, or all three. In this manner, a ruminant may ingest a ruminant feed mixture to improve milk production and/or milk fat or milk protein. The components described with respect to FIG. 1 may generally be combined in any order, may include more or fewer components, and are not limited by the order described. In various embodiments, the dietary composition may be formulated in a manner so that when consumed by the ruminant, the dietary composition maximizes particular qualities in the milk produced by the ruminant, as well as an amount of milk produced by the ruminant, as described in greater detail herein.

In some embodiments, a method of preparing a ruminant feed mixture comprises preparing a solid mixture by combining a fatty acid composition with at least one feed material, wherein the fatty acid composition comprises a fatty acid component and a surfactant component; and conditioning the solid mixture at a conditioning temperature over a period of a conditioning time to provide the ruminant feed mixture.

Referring to block 102, the method of making the ruminant feed mixture includes preparing a solid mixture by combining the fatty acid composition of block 116 with a feed material of block 114. Depending on the feed material, the feed material may be ground before being combined with the fatty acid composition. Alternatively, the fatty acid composition may be combined with the feed material and the resulting mixture may be ground. The fatty acid composition of block 116 includes a fatty acid component and a surfactant component. Anyone of the many embodiments of the fatty acid composition may be used in block 116. In some embodiments, the fatty acid composition is in prilled solid bead form or solid flake form.

The fatty acid composition and the feed material may be combined in a mixer, such as a conventional batch mixer, block 104. The ruminant feed mixture produced in block 104 may be used at this point in some embodiments of ruminant dietary compositions. However, in the case where the ruminant feed mixture is made into pellets, the method may further include blocks 106, 108, and 110.

Referring to block 106, the solid mixture prepared in block 102 and mixed in block 104 may be steam conditioned at a conditioning temperature over a period of conditioning time to provide the ruminant feed mixture. In some embodiments, a high oleic oil may be added into the solid mixture before the step of conditioning the solid mixture, block 106. In some embodiments, a high oleic oil may be added into the ruminant feed mixture material. In some embodiments, the method furthering comprises the step of adding a high oleic oil into the solid mixture before conditioning the solid mixture. In some embodiments, the method further comprises the step of adding a high oleic oil into the ruminant feed material.

After block 106, in some embodiments, the ruminant feed mixture can be pressed into pellets, block 108. In some embodiments, pelleting can be done via an extruder that pushes the conditioned ruminant feed mixture through a die. In some embodiments, the shape of the pellets can by cylindrical. However, the shape of the pellets is not limited, and pellets can be formed in any shaped desired. The conditions in the extruder may be controlled, such as via jacket cooling or heating, so that the pellet temperature is not less than about 78° C. after pressing into pellets. In some embodiments, the pellet temperature is not less than about 81° C. after pressing into pellets. In some embodiments, the pellet temperature is not less than about 70° C. after pressing into pellets.

After block 108, in some embodiments, the pellets can be cooled to ambient temperature in block 110. The pellets can cool naturally when exposed to ambient conditions or air can be blown over the pellets to assist with cooling.

Referring to block 114, in some embodiments, before the feed material is used in preparing the solid mixture in block 102, the feed material can be ground. In some embodiments, the feed material can have an average particle size of about 1 mm to about 10 mm. In some embodiments, the feed material can have an average particle size from about 10 μm to about 10 mm. In some embodiments, the feed material can have an average particle size of not greater than 10 mm.

In some embodiments, the feed material can include a roughage, a forage, a silage, a grain, or an oilseed meal. In some embodiments, the feed material can include a polysaccharide, an oligosaccharide, a cellulose, a hemicellulose, a lignocellulose, a sugar or a starch. In some embodiments, the feed material can be derived from wood. In some embodiments, the feed material can include sugar beet pulp, sugar cane, molasses, wheat bran, oat hulls, grain hulls, soybean hulls, peanut hulls, brewery by-product, yeast derivatives, grasses, hay, seeds, fruit peels, fruit pulps, legumes, plant-based feedstuffs, wheat, corn, oats, sorghum, millet, algae, or barley. In some embodiments, the feed material can include soy meals, bean meals, rapeseed meals, sunflower meals, coconut meals, palm kernel meals, olive meals, linseed meals, grapeseed meals, cottonseed meals, or mixtures thereof.

In some embodiments, the feed material can include a glucogenic precursor, a vitamin, a mineral, an amino acid, or an amino acid derivative.

In some embodiments, the glucogenic precursor can include glycerol, propylene glycol, glycerin, propanediol, calcium or sodium propionate, polyol, propionic acid, octanoic acid, steam-exploded sawdust, steam-exploded wood chips, steam-exploded wheat straw, algae, algae meal, microalgae, or combinations thereof. In some embodiments, the glucogenic precursor may generally be included in the ruminant feed mixture to provide an energy source to the ruminant that prevents gluconeogenesis from occurring within the ruminant's body.

Referring to block 102, in some embodiments, the solid mixture can have a moisture level of not greater than 12% by weight. In some embodiments, the solid mixture can have a moisture level of not greater than 10% by weight. In some embodiments, the solid mixture can have a moisture level from about 1% by weight to about 10% by weight. In some embodiments, the solid mixture can have a moisture level from about 0.1% by weight to about 10% by weight. In some embodiments, the solid mixture can include particles having a particle size not greater than 20 mm. In some embodiments, the solid mixture can include particles having a particle size from about 10 μm to about 10 mm. In some embodiments, the solid mixture has a particle size from about 10 μm to about 20 mm. In some embodiments, the solid mixture comprises the fatty acid composition from about 3% to about 40% by weight.

Referring to block 112, a liquid component can be mixed in block 104 with the solid mixture before conditioning of the solid mixture. In some embodiments, mixing of the liquid with the solid can be carried out by spraying the liquid component into the solid mixture. The liquid component can be pumped at a certain pressure through spray nozzles on the mixing vessel containing the solid mixture. In some embodiments, the liquid component can be sprayed into the solid mixture in a mist having a particle size not greater than 1500 μm. In some embodiments, the liquid component can be sprayed into the solid mixture in a mist having a particle size from about 1 μm to about 1500 μm.

In some embodiments, the mist droplets may have an average diameter of about about 2 μm, about 5 μm, about 10 μm, about 20 μm, about 25 μm, about 50 μm, about 60 μm, about 80 μm, about 100 μm, about 500 μm, about 1000 μm, and about 1500 μm. In some embodiments, the fluid droplets may have an average diameter of about 1 μm to about 2 μm, about 1 μm to about 5 μm, about 1 μm to about 10 μm, about 10 μm to about 20 μm, about 10 μm to about 50 μm, about 20 μm to about 60 μm, about 25 μm to about 80 μm, about 1 μm to about 100 μm, about 10 μm to about 100 μm, about 50 μm to about 100 μm, about 25 μm to about 100 μm, about 1 μm to about 200 μm, about 50 μm to about 200 μm, about 1 μm to about 500 μm, about 50 μm to about 500 μm, about 100 μm to about 500 μm, about 1 μm to about 1000 μm, about 100 μm to about 1000 μm, about 500 μm to about 1000 μm, about 1 μm to about 1500 μm, about 500 μm to about 1500 μm, about 1000 μm to about 1500 μm and any range between any of these values (including endpoints).

In some embodiments, the liquid component can be sprayed into the solid mixture over a period of time not less than 20 seconds. In some embodiments, the liquid component can be sprayed into the solid mixture over a period of time from about 20 seconds to about 60 seconds. In some embodiments, the liquid component can be sprayed into the solid mixture over a period of time from about 30 seconds to about 40 seconds.

In some embodiments, the liquid component can include water, or a glucogenic precursor, or both. In some embodiments, the liquid is or includes a high oleic oil that is added into the solid mixture before conditioning the solid mixture. In some embodiments, the glucogenic precursor can include glycerol, propylene glycol, glycerin, propanediol, polyol, vinasse or molasses. In some embodiments, liquid component can include glycerol, propylene glycol, glycerin, propanediol, polyol, vinasse or molasses

Referring to block 104, in some embodiments, mixing can be carried out at ambient temperature. In some embodiments, mixing can be carried out at a temperature sufficient to melt the fatty acid component. In some embodiments, mixing can be carried out at room temperature. Preparing the ruminant feed mixture at a temperature that is greater than or equal to a temperature at which the fatty acid component melts may allow the fatty acid component to slowly melt and spread with the help of the surfactant component evenly on the surface of the feed material. In some embodiments, the solid mixture may be prepared at or about room temperature (for instance, about 20° C.), and subsequently heated to a temperature that is greater than or equal to the temperature at which the fatty acid component melts.

Referring to block 106, in some embodiments, the conditioned ruminant feed mixture can include the surfactant component in amounts from about 0.001% to about 10% by weight. In some embodiments, the conditioned ruminant feed mixture can include the surfactant component in amounts from about 0.01% to about 5% by weight. In some embodiments, the ruminant feed mixture can include the fatty acid component in amounts from about 2% to about 50% by weight. In some embodiments, the ruminant feed mixture can include the fatty acid component in amounts from about 3% to about 15% by weight. In some embodiments, the ruminant feed mixture can include the fatty acid component in amounts from about 10% to about 20% by weight. In some embodiments, the ruminant feed mixture can include the fatty acid component in amounts of about 10% by weight. In some embodiments, before, during, or after block 106, a glucogenic precursor can be added into the ruminant feed mixture. In some embodiments, the method further comprises adding the glucogenic precursor into the ruminant feed mixture.

In some embodiments, steam can be used as the medium to condition the solid mixture by directly contacting the steam and the solid mixture. In some embodiments, the conditioning time is from about 5 seconds to about 10 minutes. In some embodiments, the conditioning time of the solid mixture is from about 5 seconds to about 30 minutes. In some embodiments, the conditioning time of the solid mixture is about 15 seconds to about 30 minutes. In some embodiments, the conditioning time of the solid mixture is from about 3 minutes to about 20 minutes. In some embodiments, the conditioning time is from about 3 minutes to about 30 minutes. In some embodiments, the conditioning time of the solid mixture is from about 5 minutes to about 30 minutes. In some embodiments, the conditioning temperature is not less than a temperature at which the fatty acid component melts. In some embodiments, the conditioning temperature is about 65° C. to about 75° C. In some embodiments, the conditioning temperature is, or about 73° C. to about 80° C. In some embodiments, the conditioning temperature is about 45° C. to about 65° C. In some embodiments, the conditioning temperature is about 55° C. to about 75° C. In some embodiments, the conditioning temperature is about 55° C. to about 70° C. In some embodiments, the conditioning temperature is about 73° C. to about 80° C. In some embodiments, the conditioning temperature is about 55° C. to about 80° C.

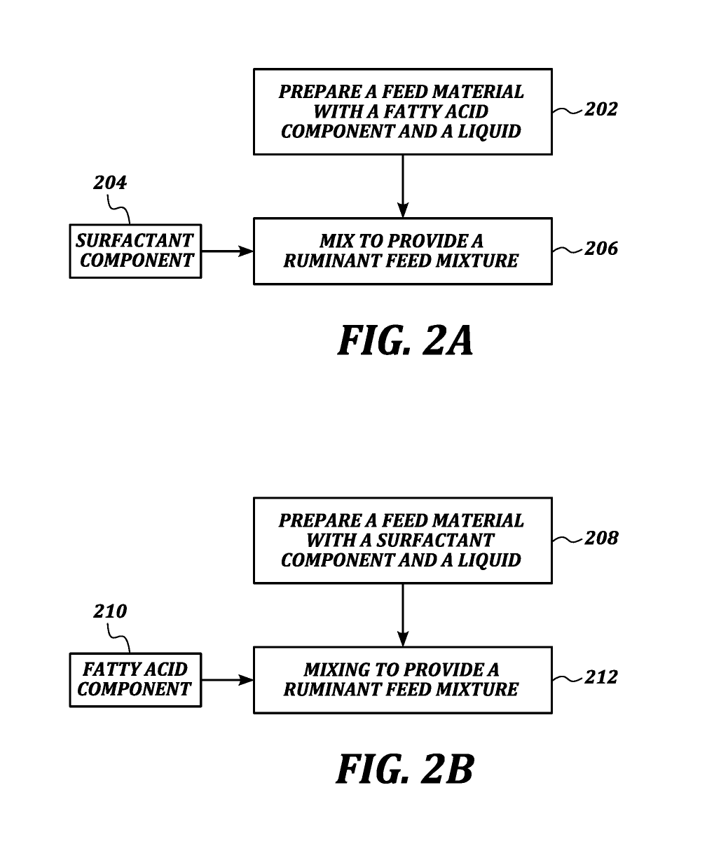

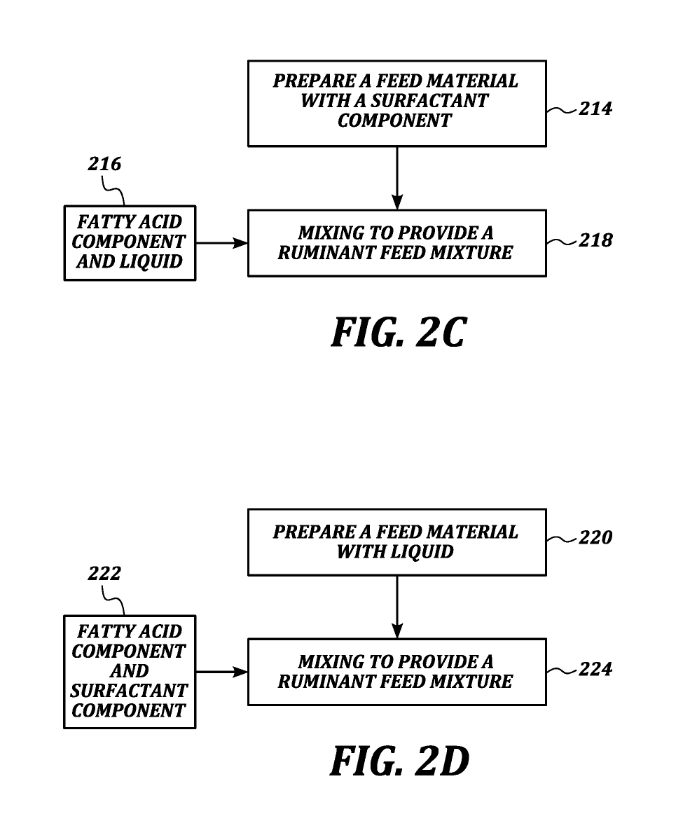

While FIG. 1 illustrates the making a ruminant feed mixture by preparing a solid mixture of a fatty acid composition including a fatty acid component and surfactant component with a feed material, and then, adding a liquid, the order of combining the components can be changed. For example, referring to FIG. 2A, the feed material, fatty acid component and liquid can be combined into a mixture, and then, the surfactant component can be added to such mixture. FIG. 2B shows that the feed material, surfactant component, and liquid can be combined, and then, the fatty acid component can be added. FIG. 2C shows that the feed material and surfactant component are combined, the fatty acid component and liquid are combined, and then, the two mixtures are combined. FIG. 2D shows that the feed material and liquid are combined, the fatty acid component and the surfactant component are combined, and then, the two mixtures are combined. Each of the four alternative schemes for combining the components can then proceed to the conditioning step, block 106, followed by the pressing step, block 108, and the cooling step, block 110, as illustrated in FIG. 1.

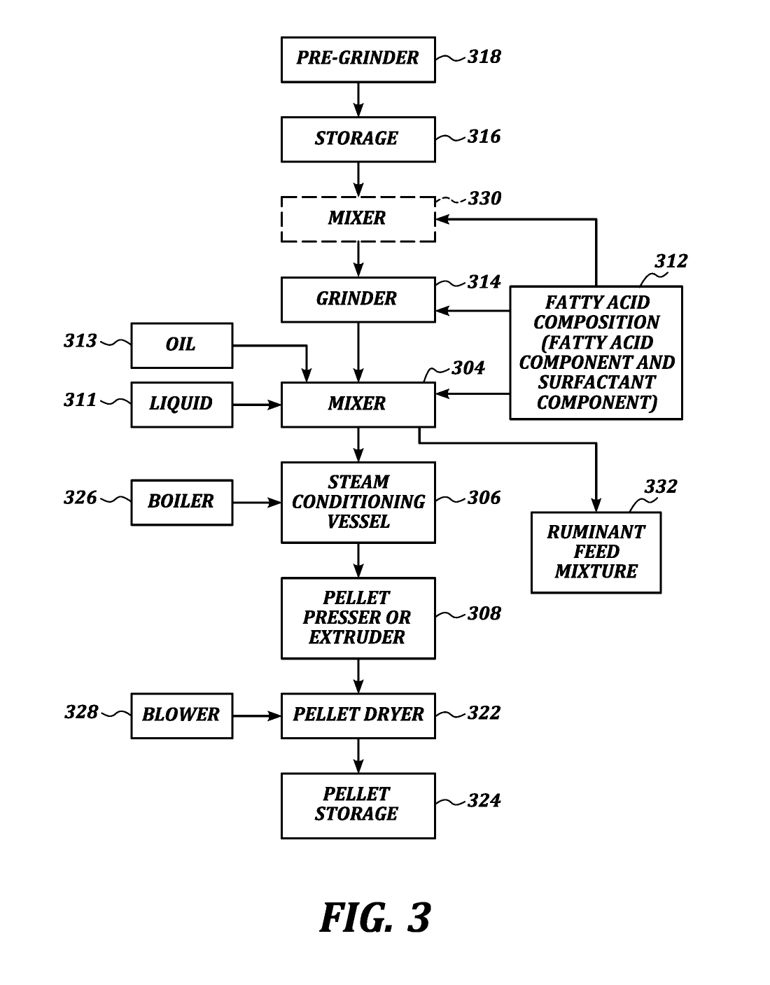

Referring to FIG. 3, one embodiment of a system for making the ruminant feed mixture and pellets is illustrated. It is to be appreciated that some components are not shown. It is also to be appreciated that some system components can be rearranged, substituted for other components, or omitted entirely in order to achieve the objective of making a ruminant feed mixture and pellets.

In some embodiments, the system includes a first mixer, block 304, wherein the first mixer contains a solid mixture including a fatty acid composition of a fatty acid component and a surfactant component. The solid mixture further includes at least one feed material. In some embodiments, the first mixer, block 304, can include a paddle mixer or a ribbon mixer. In some embodiments, the system includes a steam conditioning vessel, block 306, in communication with the first mixer, block 304, wherein the steam conditioning vessel contains the ruminant feed mixture including the solid mixture. In some embodiments, the system includes a pellet presser, expander, or extruder, block 308, in communication with the steam conditioning vessel, block 306. In some embodiments, a pellet presser has a ring die presser, a flat die presser, or a horizontal ring die presser.

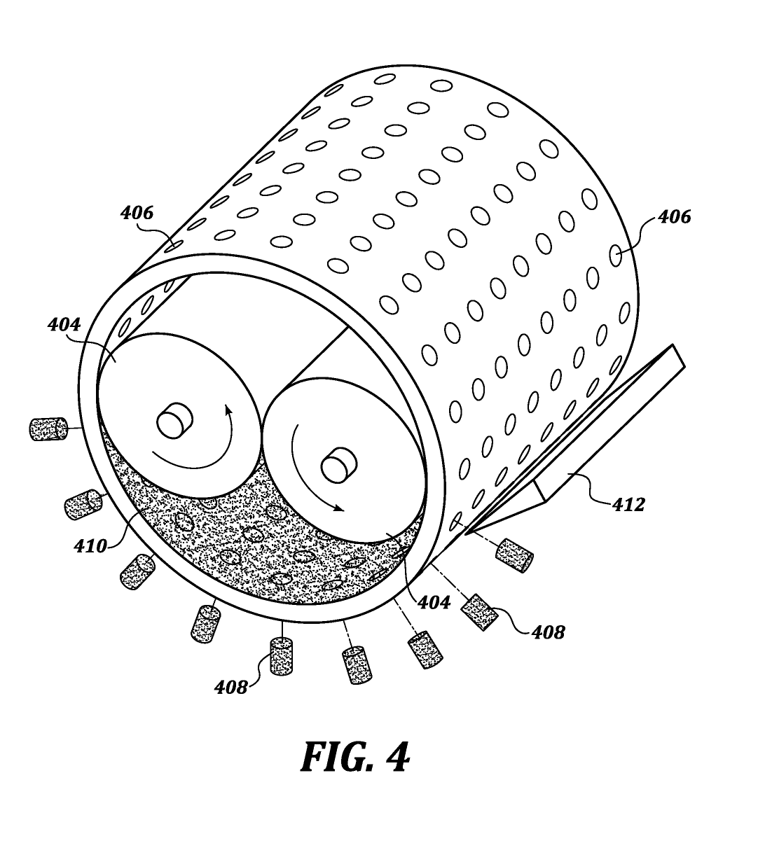

Referring to FIG. 4, a ring die presser is diagrammatically illustrated. It is to be appreciated that a ring die presser utilizing a ring die will include other components not shown. Generally, the ring die 402 has an inner diameter and an outer diameter, the difference of which defines the thickness of the individual die channels 406. The ring die 402 has a hollow center to allow one or more gears 404. The gears 404 rotate within the interior of the ring die 402 to press the ruminant feed mixture 410 out of the plurality of die channels 406. A knife 412 can scrape the ruminant feed mixture being extruded from the die channels to produce the individual pellets 408. In some embodiments, the ring die 402 has die channels 406 with a diameter from about 0.5 mm to about 100 mm. In some embodiments, the ring die 402 has die channels 406 with a diameter from about 1 mm to about 50 mm. In some embodiments, the ring die 402 has die channels 406 with a diameter from about 4 mm to about 6 mm. In some embodiments, the ring die has die channels 406 from about 1 mm to about 1000 mm thick. In some embodiments, the ring die has die channels 406 from about 10 mm to about 500 mm thick. In some embodiments, the ring die has die channels 406 from about 40 mm to about 120 mm thick. A flat die presser has a flat (planar) die with die channels. The flat die can be a circular shape and placed within a cylindrical vessel, such that the surface of the flat die is perpendicular to the vessel axis. A pair of rollers can be attached to a rotating which rotate on the surface of the die to pass the mixture through the die channels to form pellets.

Referring back to FIG. 3, the system may include one or more grinders, block 314. The grinder can grind the feed material before combining with the fatty acid composition in mixer, block 304. In some embodiments, a second additional mixer, block 330, may be included. The second mixer, block 330, can be used when the solid mixture is desired to be ground before steam conditioning. For example, instead of mixing the fatty acid composition with the feed material in mixer, block 304, the fatty acid composition and the feed material may be mixed in the mixer, block 330. The resulting solid mixture can then be ground by grinder, block 314, and from the grinder, the ground solid mixture is transferred to the mixer, block 304, where the solid mixture can be combined with a liquid, block 311. As a further option, the mixer, block 330 can be omitted, if the fatty acid composition can be introduced separately into the grinder, block 314. However, when the fatty acid composition does not need to be ground, then, the fatty acid composition can be combined with the feed material in mixer, block 304.

The solid mixture prepared in mixer, block 304, can be combined with a liquid component, block 311. The liquid component, block 311, may be stored in one or more tanks. In one embodiment, the liquid component is delivered to the mixer, block 304, via spraying. To that end, the liquid component may be pumped through a liquid injecting outlet located on the mixer, block 304. The liquid injecting outlet exits inside the mixer, block 304, and the liquid injecting outlet is configured to spray the liquid component or a liquid mixture into the solid mixture. The liquid injecting outlet design combined with a sufficient amount of pressure can produce a mist when the mixture is injected. In some embodiments, an oil may be added, block 313. To that end, the oil may be added through an oil addition outlet exiting inside the mixer, block 304. The oil addition outlet is configured to add an oil into the solid mixture.

In some embodiments, the system may include storage silos, block 316, to store one or more of the feed materials. Each different feed material may be stored separately in a different silo. Silos may be equipped with weigh scales to properly meter the feed material in the correct proportions out of the silos. In some embodiments, feed material in the form of grain may be pre-ground by pre-grinders, block 318, before being stored in the silos, block 316. The pre-grinders of block 318, may be configured to separately grind each one of the feed material components before they are stored. Alternatively, all feed materials can be ground together in the pre-grinder.

From storage, block 316, the feed material may be metered into grinder block 304, or mixer block 330, or mixer block 304.

In some embodiments, the fatty acid composition, block 312, can be stored and metered separately from the feed material. The fatty acid composition can be metered in the correct proportions into the mixer, block 330, the grinder, block 314, or the mixer, block 304.

Pre-grinders, block 318, may be configured to grind the feed materials to various sizes, such as particle size (for instance, measured in millimeters), mesh sizes, surface areas, or the like. The feed materials may be ground to a particle size of about 1 millimeters, about 2 millimeters, about 5 millimeters, about 7 millimeters, about 10 millimeters, and values or ranges between any two of these values (including endpoints). In some embodiments, before preparing the solid mixture, the feed material is ground to an average particle size of about 1 mm to about 10 mm. Where the solid mixture is ground in grinder, block 314, the solid mixture may be ground to a particle size of about 1 millimeter, about 2 millimeters, about 5 millimeters, about 7 millimeters, about 10 millimeters, and values or ranges between any two of these values (including endpoints). In some embodiments, the various solid components may have a varying distribution of particle sizes based upon the feed material.

Pre-grinding and grinding, blocks 318 and 314, may be performed by various grinding devices known to those having ordinary skill in the art, such as a hammer mill, a roller mill, a disk mill, or the like. Grinders, blocks 318 and 314, may include any process for reducing the particle size of a material, such as smashing, mashing, shocking, hammering, cutting, or the like. Grinding may provide various benefits, such as improving certain characteristics of the ruminant feed mixture. For instance, even and fine particle size may improve the mixing of different feed materials and pelleting. According to certain embodiments, grinding may be configured to decrease a particle size of the feed materials, for example, to increase the surface area open for enzymes in the gastrointestinal tract, which may improve the digestibility of nutrients, and to increase the palatability of the feed.

Referring to mixer, block 304, in some embodiments, the ruminant feed mixture produced therein can be collected, block 332, to be used in the making of various ruminant dietary compositions.

In some embodiments, the ruminant feed mixture is used for making pellets. The dietary compositions for ruminants or other animals can be made from the ruminant feed mixture of block 332 or from the pellets. In embodiments where the ruminant feed mixture is to be made into pellets, the system may further include, blocks 306, 308, 322, 324, 326, and 328, for example. It should be appreciated that FIG. 3 is highly diagrammatical, and all the equipment for making pellets may not be shown.

Referring to FIG. 3, after the mixer, block 304, the ruminant feed mixture may be stored in pelleting bins (not shown) wherein the temperature and relative humidity can be controlled. In some embodiments, however, the ruminant feed mixture may bypass the pelleting bins and be transferred directly to a steam conditioning vessel, block 306. The steam conditioning vessel receives steam from the boiler, block 326. The steam is used to condition the ruminant feed mixture prior to the pelleting process.

In some embodiments, the ruminant feed mixture may be pressed into pellets. The steam conditioned ruminant feed mixture may be pressed into pellets or extruded using a pellet presser or extruder, block 308. In some embodiments, the ruminant feed mixture may be expanded, such as by using air. The resulting pressed pellets may have a diameter of about 5 to about 6 mm and a thickness of about 60 mm. However, other sizes can be used.

In some embodiments, after pressing, the pellets may be placed in pellet dryer, block 322. A blower, block 328, can blow ambient air or refrigerated and dehumidified air to be used in the pellet dryer. The dried pellets may then undergo size-sorting via a plurality of sieves, to select pellets of a particular size. The finished pellets may be stored in silos, block 324, and thereafter bulk loaded or bag loaded for shipment. Bulk loading for example, may include loading the pellets directly into a delivery vehicle. Bag loading may include filling bags with ruminant feed mixture pellets.

The ruminant dietary compositions made from the ruminant feed mixture or pellets can be used when feeding ruminants. However, in some embodiments, the ruminant feed mixture or pellets can be used to feed animals that are not ruminants. In some embodiments, a method of increasing milk fat, milk protein or milk production in ruminants may include providing dietary compositions including the ruminant feed mixture as described herein to the ruminant for ingestion in the form of the pellets or other manner. The method includes collecting milk from the ruminant after the ruminant has ingested the ruminant feed mixture. In some embodiments, the collected milk has a higher milk fat content, milk protein content, or yield compared to milk before the ruminant ingested the ruminant feed mixture. In some embodiments, the ruminant will produce a greater quantity of milk compared to before the ruminant ingested the ruminant feed mixture. In some embodiments, a ruminant dietary composition is made by the method including any one of the embodiments for making a ruminant feed mixture.

In some embodiments, a dietary composition comprises a fatty acid component, a surfactant component, and a feed material. In some embodiments, the ruminant dietary composition includes a fatty acid component, a surfactant component, a high oleic oil, and a feed material. In some embodiments, the fatty acid composition melts at not less than 50° C., wherein the fatty acid component has an Iodine Value not greater than 25, and wherein the high oleic oil has an oleic content not less than 35% by weight.

In some embodiments, a dietary composition comprises a fatty acid component, a surfactant component, and a feed material. In some embodiments, the fatty acid component melts at not less than 50° C. In some embodiments, the fatty acid component has an Iodine Value not greater than 30. In some embodiments, the surfactant component comprises a surfactant derived from oleic acid. In some embodiments, the surfactant component comprises polysorbate or sorbate. In some embodiments, the surfactant component comprises polysorbitan oleate not less than 30%, 45%, or 50% by weight.

In some embodiments, the ruminant dietary composition can consist of a fatty acid component, a surfactant component, a high oleic oil, and a feed material, wherein the fatty acid composition melts at not less than 40° C., wherein the fatty acid component has an Iodine Value not greater than 30, and wherein the high oleic oil has an oleic content not less than 35% by weight. In some embodiments, a dietary composition consists of a fatty acid component; a surfactant component; a high oleic oil; and a feed material, wherein the fatty acid composition melts at not less than 50° C.; wherein the fatty acid component has an Iodine Value not greater than 30; and wherein the high oleic oil has an oleic content not less than 35% by weight. In some embodiments, the ruminant dietary composition and include about 3% to about 40% by weight of the fatty acid component, about 0.01% to about 10% by weight of a surfactant component, and about 1% to about 30% by weight of the high oleic oil.

In some embodiments, the ruminant dietary composition can be in the form of a dry particle, a pellet, a liquid suspension, a paste, or an emulsion, for example. In some embodiments, providing the dietary composition to the ruminant for the ruminant to consume may result in an increase in the production of milk or an increase in the fat content of the milk produced, or both. These increases may generally be relative to a similar ruminant that does not receive the dietary composition, an average of similar ruminants not receiving the dietary composition, or an average of the milk production quantity and fat content of the same ruminant when not provided the dietary composition.

In some embodiments, the milk production in either weight or volume percent may increase by an amount of about 0.01% to about 10% by weight, including, by weight, about 0.01%, about 0.1%, about 0.2%, about 0.3%, about 0.4%, about 0.5%, about 1%, about 5%, about 8%, about 9%, about 10%, or any value or range between any two of these values (including endpoints).

In some embodiments, the milk fat content or yield may increase in either weight or volume percent by an amount of about 0.001% to about 15% by weight, including, by weight, about 0.001%, 0.01%, about 1%, about 2%, about 3%, about 10%, about 15%, or any value or range between any two of these values (including endpoints) compared to ruminants that do not ingest the dietary composition.

In some embodiments, the milk protein content or yield may increase in either weight or volume percent by an amount of about 0.001% to about 10% by weight, including, by weight, about 0.001%, 0.01%, about 0.05%, about 0.2%, about 0.5%, about 1%, about 2%, about 3%, about 10%, about 15%, or any value or range between any two of these values (including endpoints) compared to ruminants that do not ingest the dietary composition.

In some embodiments, a method of increasing milk fat content of milk produced by a ruminant may include providing a ruminant feed mixture to the ruminant for ingestion, and collecting milk from the ruminant after the ruminant has ingested the ruminant feed mixture, wherein milk collected from the ruminant has a higher milk fat content compared to milk before the ruminant ingested the ruminant feed mixture. The ruminant can be a cow, goat, or sheep.

In some embodiments, a method of increasing milk protein content of milk produced by a ruminant may include providing a ruminant feed mixture to the ruminant for ingestion, and collecting milk from the ruminant after the ruminant has ingested the ruminant feed mixture, wherein milk collected from the ruminant has a higher milk protein content compared to milk before the ruminant ingested the ruminant feed mixture. The ruminant can be a cow, goat, or sheep.

In some embodiments, a method of increasing milk production by a ruminant may include providing a ruminant feed mixture to the ruminant for ingestion, and collecting milk from the ruminant after the ruminant has ingested the ruminant feed mixture, wherein the milk production from the ruminant is higher compared to a milk production before the ruminant ingested the ruminant feed mixture. The ruminant can be a cow, goat, or sheep.

In the description herein, reference is made to the accompanying drawings, which form a part hereof. In the FIGURES, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the FIGURES, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of plural, singular, or both herein, those having skill in the art can translate from the plural to the singular, from the singular to the plural, or both as is appropriate to the context. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or FIGURES, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

### EXAMPLES

### Example 1: Production of Feed Pellets Containing a Fatty Acid Composition with Long Conditioning

A fatty acid composition containing free palmitic acid and a polyethylene sorbitol ester surfactant (polysorbitan 80) is mixed together with the feed materials as listed in TABLE 1 to provide a solid mixture. The solid mixture is steam conditioned at a temperature between about 50° C. to about 70° C. for at least 10 minutes. The resulting mixture is processed into feed pellets designated as Pellet A.

TABLE 1

| Ingredient | Wt. % |
|---|---|
| Barley | 50.00 |
| Molassed sugar beet pulp | 3.15 |
| Molasses | 5.00 |
| Calcium carbonate | 1.20 |
| Sodium chloride | 0.60 |
| Sodium bicarbonate | 0.40 |
| Magnesium oxide | 0.20 |
| Rapeseed meal | 35.00 |
| Premix of vitamins and trace elements | 0.20 |
| PrimaFat 16 E | 4.25 |

### Example 2: Production of Feed Pellets Containing a Fatty Acid Composition with Short Conditioning

A fatty acid composition containing free palmitic acid and a polyethylene sorbitol ester surfactant (polysorbitan 80) is mixed together with the feed materials as listed in TABLE 1 to provide a solid mixture. The solid mixture is steam conditioned at a temperature between about 40° C. to about 50° C. for a time not exceeding 3 minutes. The resulting mixture is processed into feed pellets designated as Pellet B.

### Example 3: Production of Feed Pellets Containing a Fatty Acid Composition and Rapeseed Oil

A fatty acid composition containing free palmitic acid and glyceryl polyethyleneglycol ricnoleate E484 is mixed together with the feed materials as listed in TABLE 2 to provide a solid mixture. Rapeseed oil is added into the solid mixture and the resulting mixture is steam conditioned at a temperature between about 50° C. to about 70° C. for at least 10 minutes. The resulting mixture is processed into feed pellets designated as Pellet C.

TABLE 2

| Ingredient | Wt. % |
|---|---|
| Barley | 50.00 |
| Molassed sugar beet pulp | 3.37 |
| Molasses | 5.00 |
| Calcium carbonate | 1.20 |
| Sodium chloride | 0.60 |
| Sodium bicarbonate | 0.40 |
| Magnesium oxide | 0.20 |
| Palmitic acid | 3.00 |
| Emulsifier (Bredol) | 0.03 |
| Rapeseed meal | 35.00 |
| Premix of vitamins and trace elements | 0.20 |
| Rapeseed oil | 1.00 |

### Example 4: Animal Feeding Trial of Pellet a, B and C

An animal feeding trial was carried out with feeding treatments containing Pellet A, B and C. 24 Ayrshire multiparous cows were used in the trial. All testing animals had a milk day of at least five weeks. The trial was carried out in a 3×4 Latin square design including 3 treatment and 4 cycles. Each cycle period lasted three weeks. Cows were divided into groups based on the production capacity and multiparousity. In each period, each group was treated with one feeding treatment including Pellet A, B or C. All the cows went through all the feeding treatments. The results shown in TABLE 3 were calculated based on the measurements in the last week of each treatment. Collection week started on Thursday and continued to Thursday of the following week.

TABLE 3
Milk yields and concentrations from the feeding trial

| | | |
|---|---|---|
| Pellet A group | Pellet B group | Pellet C group |

Yields, Kg/day

| | | | |
|---|---|---|---|
| Milk | 40.5 | 39.9 | 41.2 |
| ECM | 46.3 | 45.9 | 46.7 |
| Fat | 2.10 | 2.06 | 2.08 |
| Protein | 1.46 | 1.45 | 1.47 |
| Lactose | 1.81 | 1.79 | 1.85 |

Concentration, wt. %

| | | | |
|---|---|---|---|
| Fat | 5.13 | 5.17 | 5.06 |
| Protein | 3.62 | 3.65 | 3.58 |
| Lactose | 4.46 | 4.47 | 4.50 |
| Urea, mg/100 ml | 19.4 | 20.5 | 19.3 |

The embodiments of the invention in which an exclusive property or privilege is claimed are defined as follows:

1. A dietary composition for ruminant, comprising,
a fatty acid composition, comprising a fatty acid component and a surfactant component; and
a feed material,
wherein the fatty acid component comprises at least 70% by weight of a rumen stable fatty acid; and wherein a weight/weight ratio of the surfactant component to the fatty acid component is about 1:100 to about 1:1.

2. The dietary composition of claim 1, wherein a weight/weight ratio of the surfactant component to the fatty acid component is about 1:20 to about 1:2.

3. The ruminant dietary composition of claim 1, wherein the fatty acid component comprises at least about 80% of free fatty acid by weight.

4. The dietary composition of claim 1, wherein the fatty acid component comprises at least 70% of a palmitic acid compound by weight.

5. The dietary composition of claim 1, wherein the fatty acid component comprises at least 95% of a palmitic acid compound by weight.

6. The dietary composition of claim 4, wherein the palmitic acid compound comprises free palmitic acid, palmitate triglyceride, one or more salts of palmitic acid.

7. The dietary composition of claim 6, wherein the salt of palmitic acid comprises sodium palmitate, calcium palmitate, magnesium palmitate, ammonium palmitate, zinc palmitate, aluminum palmitate, copper palmitate, iron palmitate, chromium palmitate, selenium palmitate, or a combination thereof.

8. The dietary composition of claim 1, wherein the fatty acid component comprises at least 90% of free palmitic acid by weight.

9. The dietary composition of claim 1, wherein the fatty acid component comprises a stearic acid compound.

10. The dietary composition of claim 1, wherein the fatty acid component comprises an oleic acid compound.

11. The dietary composition of claim 10, wherein the oleic acid compound comprises free oleic acid, an oleic acid ester, mono-, di-, or triglyceride of oleic acid, a high oleic oil, or a combination thereof.

12. The dietary composition of claim 10, wherein the fatty acid component comprises from about 1% to about 50% by weight of the oleic acid compound.

13. The dietary composition of claim 11, wherein the high oleic oil comprises not less than 35% by weight of oleic content.

14. The dietary composition of claim 11, wherein the high oleic oil comprises not less than 40% by weight of oleic content.

15. The dietary composition of claim 11, wherein the high oleic oil comprises not less than 50% by weight of oleic content.

16. The dietary composition of claim 1, wherein the fatty acid component comprises olive oil, pecan oil, rapeseed oil, peanut oil, macadamia oil, sunflower oil, corn oil, cottonseed oil, flaxseed oil, palm oil, soybean oil, grape seed oil, sea buckthorn oil, chicken fat, turkey fat, lard, or a combination thereof.

17. The dietary composition of claim 1, wherein the fatty acid component comprises from about 1% to about 50% by weight of high oleic oil.

18. The dietary composition of claim 1, wherein the fatty acid component comprises from about 1% to about 40% by weight of rapeseed oil.

19. The dietary composition of claim 1, wherein the fatty acid component comprises free palmitic acid and rapeseed oil at a weight/weight ratio from about 50:1 to about 1:1.

20. The method of claim 1, wherein the fatty acid component comprises unsaponifiable matter no greater than 45% by weight.

21. The method of claim 1, wherein the fatty acid component comprises unsaponifiable matter no greater than 15% by weight.

22. The dietary composition of claim 1, wherein the fatty acid component has an Iodine Value not greater than 25.

23. The dietary composition of claim 1, wherein the fatty acid component has an Iodine Value not greater than 15.

24. The dietary composition of claim 1, wherein the surfactant component comprises a non-ionic emulsifier.

25. The dietary composition of claim 1, wherein the surfactant component comprises an ionic emulsifier.

26. The dietary composition of claim 1, wherein the surfactant component comprises an emulsifier having a hydrophilic-lipophilic balance value of about 10 to about 20.

27. The dietary composition of claim 1, wherein the surfactant component comprises calcium stearoyl dilaciate, glycerol ester, polyglycerol ester, sorbitan ester, polysorbitan ester, polyethylene glycol ester, sugar ester, monoglyceride, acetylated monoglyceride, lactylated monoglyceride, or derivatives thereof.

28. The dietary composition of claim 1, wherein the surfactant component comprises polyoxyethylene stearate, polysorbate, polyoxyethylene sorbitan monolaurate, polyoxyethylene sorbitan monooleate, polyoxyethylene sorbitan monopalmitate, polyoxyethylene sorbitan monostearate, polyoxyethylene sorbitan tristearate, ammonium phosphatides, sodium or potassium or calcium salts of fatty acids, magnesium salts of fatty acids, mono- and diglycerides of fatty acids, acetic acid esters of mono- and diglycerides of fatty acids, lactic acid esters of mono- and diglycerides of fatty acids, citric acid esters of mono- and diglycerides of fatty acids, mono- and diacetyl tartaric acid esters of mono- and diglycerides of fatty acids, acetic acid esters of mono- and diglycerides of fatty acids, tartaric acid esters of mono- and diglycerides of fatty acids, sucrose esters of fatty acids sucroglycerides, polyglycerol esters of fatty acids polyglycerol polyricinoleate, propane-1,2-diol esters of fatty acids, thermally oxidised soya bean oil interacted with mono- and diglycerides of fatty acids, sodium stearoyl-2-lactylate, calcium stearoyl-2-lactylate, sorbitan monostearate, sorbitan tristearate, sorbitan monolaurate, sorbitan monooleate, sorbitan monopalmitate, polysorbate 20, polysorbate 40, polysorbate 60, polysorbate 80, or derivatives thereof.

29. The dietary composition of claim 28, wherein the sodium or potassium or calcium salts of fatty acids comprises sodium or potassium or calcium salts of distilled palm fatty acids.

30. The dietary composition of claim 1, wherein the surfactant component comprises a surfactant derived from oleic acid.

31. The dietary composition of claim 1, wherein the surfactant component comprises a non-ionic oleate ester derived surfactant.

32. The dietary composition of claim 1, wherein the surfactant component comprises an ionic oleic acid derived surfactant.

33. The dietary composition of claim 1, wherein the surfactant component comprises sodium oleate, potassium oleate, calcium oleate, ammonium oleate, sorbitan oleate, sorbitan mono-, di- or trioleate, polysorbate oleate, glyceryl oleate, methyl oleate, ethyl oleate, PEG oleate, triethanolamine oleate (TEA oleate), or a combination thereof.

34. The dietary composition of claim 1, further comprising a high oleic oil, wherein the high oleic oil has an oleic content not less than 35% by weight.

35. The dietary composition of claim 34, wherein the high oleic oil comprises rapeseed oil.

36. The dietary composition of claim 34, wherein the high oleic oil comprises olive oil.

37. The dietary composition of claim 1, wherein the feed material comprises a roughage, a forage, a silage, a grain, or an oilseed meal.

38. The dietary composition of claim 1, wherein the feed material comprises a polysaccharide, an oligosaccharide, a cellulose, a hemicellulose, a lignocellulose, a sugar or a starch.

39. The dietary composition of claim 1, wherein the feed material comprises sugar beet pulp, sugar cane, molasses, wheat bran, oat hulls, grain hulls, soybean hulls, peanut hulls, brewery by-product, yeast derivatives, grasses, hay, seeds, fruit peels, fruit pulps, legumes, plant-based feedstuffs, wheat, corn, oats, sorghum, millet, algae, or barley.

40. The dietary composition of claim 1, wherein the feed material comprises soy meals, bean meals, rapeseed meals, sunflower meals, coconut meals, palm kernel meal, olive meals, linseed meals, grapeseed meals, cottonseed meals, or mixtures thereof.

41. The dietary composition of claim 1, wherein the feed material comprises a glucogenic precursor, a vitamin, a mineral, an amino acid, or an amino acid derivative.

42. The dietary composition of claim 1, comprising:
about 0.5% to about 40% by weight of the fatty acid composition, wherein the fatty acid composition comprises from about 50% to about 99% by weight of the fatty acid component and from about 0.01% to about 20% by weight of the surfactant component; and
about 50% to about 99% by weight of the feed material.

43. The dietary composition of claim 42, further comprising about 1% to about 30% by weight of a high oleic oil.

44. The dietary composition of claim 1, wherein the composition is in pellet form.

45. The dietary composition of claim 1, wherein the composition is in mash mixture form.

46. A method of preparing a ruminant feed mixture, comprising:
preparing a solid mixture by combining a fatty acid composition with at least one feed material, wherein the fatty acid composition comprises a fatty acid component and a surfactant component; and
conditioning the solid mixture at a conditioning temperature over a period of a conditioning time to provide the ruminant feed mixture.

47. The method of claim 46, wherein the fatty acid composition is in prilled solid bead form or solid flake form.

48. The method of claim 46, furthering comprising the step of adding a high oleic oil into the solid mixture before conditioning the solid mixture.

49. The method of claim 46, further comprising the step of adding a high oleic oil into the ruminant feed material.

50. The method of claim 46, wherein the feed material has an average particle size from about 10 μm to about 10 mm.

51. The method of claim 46, wherein the solid mixture has a moisture level of not greater than 12% by weight.

52. The method of claim 46, wherein the solid mixture has a particle size from about 10 μm to about 20 mm.

53. The method of claim 46, wherein, before conditioning, mixing a liquid component with the solid mixture.

54. The method of claim 53, wherein mixing is carried out at ambient temperature.

55. The method of claim 53, wherein the liquid component comprises water.

56. The method of claim 53, wherein the liquid component comprises a glucogenic precursor.

57. The method of claim 46, wherein the ruminant feed mixture comprises the surfactant component from about 0.01% to about 5% by weight.

58. The method of claim 46, wherein the solid mixture comprises the fatty acid composition from about 3% to about 40% by weight.

59. The method of claim 46, further comprising adding a glucogenic precursor into the ruminant feed mixture.

60. The method of claim 46, further comprising:
before preparing the solid mixture, grinding the feed material to an average particle size of about 1 mm to about 10 mm.

61. The method of claim 46, wherein the conditioning time is from about 5 seconds to about 10 minutes.

62. The method of claim 46, wherein the conditioning time is from about 3 minutes to about 30 minutes.

63. The method of claim 46, wherein the conditioning temperature is not less than a temperature at which the fatty acid component melts.

64. The method of claim 46, wherein the conditioning temperature is about 45° C. to about 65° C.

65. The method of claim 46, wherein the conditioning temperature is about 55° C. to about 70° C.

66. The method of claim 46, further comprising pressing the ruminant feed mixture into pellets.

67. The method of claim 66, wherein the pellets reach not less than about 70° C. after the pressing.

68. The method of claim 66, wherein the pellets reach not less than about 81° C. after the pressing.

69. The method of claim 66, further comprising cooling the pellets to ambient temperature.

70. A system for making a ruminant feed, comprising
a mixer, wherein the mixer contains a solid mixture comprising a fatty acid composition and at least one feed material, wherein the fatty acid composition comprises a fatty acid component and a surfactant component;
a steam conditioning vessel, wherein the steam conditioning vessel contains a ruminant feed mixture comprising the solid mixture; and
a pellet presser, expander, or extruder.

71. The system of claim 70, wherein the mixer comprises a paddle mixer or a ribbon mixer.

72. The system of claim 70, wherein the pellet presser is a ring die presser or a flat die presser.

73. The system of claim 72, wherein the ring die presser or the flat die presser has a die diameter from about 4 mm to about 6 mm.

74. The system of claim 72, wherein the ring die presser or the flat die presser has a die channel from about 40 mm to about 120 mm.

75. The system of claim 70, further comprising an oil addition outlet existing inside the mixer, wherein the oil addition outlet is configured to add an oil into the solid mixture.

76. The system of claim 70, further comprising a liquid injecting outlet exiting inside the mixer, wherein the liquid injecting outlet is configured to spray a liquid component into the solid mixture.

77. A method of increasing milk yield, milk fat, or milk protein of milk produced by a ruminant, comprising:
providing a ruminant feed mixture to the ruminant for ingestion, wherein the ruminant feed mixture is made by the method of any one of claims 46-69; and
collecting milk from the ruminant after the ruminant has ingested the ruminant feed mixture, wherein milk collected from the ruminant has a higher milk fat content, milk protein content, or both compared to milk before the ruminant ingested the ruminant feed mixture.

78. The method of claim 77, wherein the ruminant is a cow, goat, or sheep.

79. A ruminant dietary composition made by the method of any one of claims 46-69.
